(19) United States
(12) Patent Application Publication
(10) Pub. No.: US 2022/0046905 A1
(43) Pub. Date: Feb. 17, 2022

(54) FISH POT

(71) Applicant: Innomar AS, Grimstad (NO)

(72) Inventor: Tore Halvorsen, Fevik (NO)

(73) Assignee: Innomar AS, Grimstad (NO)

(21) Appl. No.: 17/312,795

(22) PCT Filed: Dec. 10, 2019
(86) PCT No.: PCT/NO2019/050270

§ 371 Date: Jun. 10, 2021

(30) Foreign Application Priority Data
Dec. 12, 2018 (NO) 20181596

(51) Int. Cl. A01K 69/06

(52) U.S. Cl. CPC A01K 69/06

(57) ABSTRACT

A pot arranged for catching a fish. The pot has a pot chamber, with a primary inlet funnel extending inwards in the pot chamber. Under the pot chamber, a framework forming an antechamber arranged to house a fish is arranged. The antechamber includes a lower inlet funnel which extends inwards in the antechamber.

### CROSS-REFERENCE TO RELATED APPLICATIONS

This application is the U.S. national stage application of International Application PCT/NO2019/050270, filed Dec. 10, 2019, which international application was published on Jun. 18, 2020, as International Publication WO 2020/122731 in the English language. The International Application claims priority of Norwegian Patent Application No. 20181596, filed Dec. 12, 2018. The international application and Norwegian application are both incorporated herein by reference, in entirety.

### FIELD

The invention relates to a pot. More specifically, the invention relates to a fish pot arranged for catching cod.

### BACKGROUND

Cod (Gadus morhua) is found along the entire coast of Norway and out in the ocean. It is widespread in the northern part of the Atlantic Ocean, and it is counted as one of the most important species of fish in the North-Atlantic fisheries. Some stocks migrate far offshore when migrating for food, for example the Northeast Arctic cod.

By and large, the cod swims calmly around, sniffing out something edible along the bottom. The cod has well developed senses of smell and taste, which it uses when hunting for food. When the cod is searching for food, it uses several senses: the lateral line organ, the sense of smell, the hearing and the sense of taste.

When the cod is moving upwards in the water column hunting for food, its hunter instinct intensifies and it uses its vision and the lateral line to a greater extent to find the prey fish. In other words, the cod is a fish with good all-round hunting characteristics which is good at adapting to the conditions. The adaptability and diverse hunting characteristics of the cod make the cod be found almost anywhere along the Norwegian coast, and many different fishing methods be usable for catching it.

The trawl is the most effective fishing implement, followed by the Danish seine and the net. A substantial drawback of trawling and partially also seining is that the fish suffer crush damage when large quantities of fish are pushed together in the trawl or seine net. It is also known that trawling can give poor bleeding of the fish because it may take a long time to gut and bleed out all the fish. It is also a problem that the trawl may damage the sea floor. The trawl and the seine also produce considerable amounts of microplastics because of abrasion against the sea floor. Figures from the food research institute Nofima show that in trawling, the proportion of quality fish may be as small as 50 percent, depending on the size of the catch.

A line and a handline are examples of fishing implements that are gentler than a trawl, and these methods are much used by smaller fishing boats. For these catching implements, figures from Nofima show quality proportions of 71 and 91 percent, respectively. A drawback of a handline and a line is that a hook is used, which can stress the fish and cause lesions in the fish.

A pot, for example a fish trap or a cod pot, is the gentlest fishing implement, and is well suited for fish that are to be carried alive to the market. The pot comprises an enclosure into which the fish is lured, and where it may be kept without suffering any damage as long as the fish has access to feed. Pot-fishing therefore makes it possible for fishermen to avoid fishing in bad weather, as the pots may be deployed before the bad weather sets in and emptied when the bad weather is over.

The drawback of a pot or a trap is that these fishing implements are not very effective, and therefore they are used to a limited extent among professional fishermen. At the same time, the demand for wild fish of a high quality is increasing. The fish industry therefore seeks new catching methods that are both gentle and efficient.

### SUMMARY

The invention has for its object to remedy or reduce at least one of the drawbacks of the prior art or at least provide a useful alternative to the prior art.

The object is achieved through the features that are specified in the description below and in the claims that follow.

The invention relates to a pot, more specifically a pot arranged for catching a fish. The pot comprises a top ring surrounding a pot top, a bottom ring surrounding a pot bottom, and a surrounding side wall formed between the top ring and the bottom ring. The pot top, pot bottom and side wall form a pot chamber. The pot bottom comprises a primary inlet funnel extending inwards in the pot chamber. Under the pot bottom, a framework is arranged, comprising the bottom ring and a lower frame ring arranged to rest against a supporting surface. The framework forms an antechamber arranged to house a fish.

The pot top, the pot bottom, the surrounding side wall and the surrounding antechamber wall, may be formed of a net. The fish may be a fish that typically searches for food on or near a sea floor, for example a cod fish.

The effect of the framework is that the pot may stand on a supporting surface, for example a sea floor, and that fish searching for food along the sea floor may swim into the antechamber below the pot bottom and be lured up through the primary inlet funnel and into the pot chamber.

By soft floor conditions, the bottom ring may sink into the supporting surface. The distance between the bottom ring and the lower frame ring may therefore be overdimensioned, so that the fish can swim into the antechamber even if the lower frame ring has sunk into the supporting surface.

When the fish is swimming along the sea floor and discovers a bait higher in the water column, for example a krill, the fish will typically move towards the bait. The pot that is described herein is designed to utilize such a behavioural pattern of the fish.

The primary inlet funnel may be connected to the pot bottom. The primary inlet funnel may be an extension of the pot bottom. The primary inlet funnel may be part of the pot bottom. The primary inlet funnel extends upwards in the water column and into the pot chamber when the pot is in a position of application.

The primary inlet funnel may include an oblong opening inside the pot chamber.

The effect of the oblong opening is that a fish can easily swim through the funnel-shaped primary inlet funnel and into the pot chamber, whereas the fish will have problems in swimming back and out through the opening. Trials carried out by the applicant have shown that it is more difficult for the fish to swim out of the pot chamber through an oblong opening than a round opening.

Along an outer circumference of the antechamber, between the bottom ring and the lower frame ring, a lower inlet funnel is arranged, extending inwards in the antechamber. The lower inlet funnel may surround the antechamber. The lower inlet funnel may surround one or more portions of the antechamber.

The effect of the lower inlet funnel is that the fish can be led into the antechamber below the pot bottom while, at the same time, fish that have got into the antechamber are prevented from swimming out of the pot. It is known that a cod that becomes scared or bumps into something will move upwards in the water column. When a cod that is in the antechamber bumps against an inside of the lower inlet funnel, the cod will instinctively change its swimming direction so that it moves upwards and into the primary inlet funnel.

The lower inlet funnel may include an upper collar. The lower inlet funnel may include a lower collar. The lower inlet funnel may be formed of a lower inlet collar and the pot bottom.

The upper and lower funnels may be connected by a plurality of connecting elements so that the upper and lower funnels together form a slot-shaped inlet.

The lower frame ring may have a diameter which is larger than the diameter of the bottom ring, so that the framework forms a conical shape.

The effect of the conical shape is that two or more pots can be stacked with a smallest possible height.

The bottom ring and the lower frame ring are part of the framework. The bottom ring and the lower frame ring are interconnected by at least one connecting element. In an advantageous embodiment, the bottom ring and the lower frame ring are interconnected by at least three connecting elements. By a plurality of pots being stackable in height, the need for storage space is reduced, which is particularly important on a vessel with limited space. A stacking of the pots as described herein is also advantageous from a safety aspect, as the pots cannot be displaced individually in a horizontal direction.

The bottom ring and the lower frame ring may be circular.

The effect of the annular shape that is described herein is that a circular pot is gentler to the sea floor and the surroundings than a polygonal pot. An annular pot further has a lower risk of sticking to the sea floor or scraping up the sea floor than a pot with sharp corners. It may also be gentler to hulls and easier to handle than a polygonal pot. A round pot will also be less likely to start rotating in consequence of impacts against a vessel side than a pot of a polygonal shape.

The top ring may be circular. The top ring may have a smaller diameter than the bottom ring, so that the pot chamber forms a conical shape. The top ring may have a diameter of 170 cm, for example. The bottom ring may have a diameter of 190 cm, for example. The lower frame ring may have a diameter of 200 cm, for example. The pot may have a height of 120 cm, for example. The size of the pot may be adapted for the fish that is to be caught.

The primary inlet funnel may include an oblong opening inside the pot chamber.

The effect of the oblong opening is that a fish can easily swim through the funnel-shaped primary inlet funnel and into the pot chamber, whereas the fish will have problems in swimming back out through the opening. Trials carried out by the applicant have shown that it is more difficult for the fish to swim out of the pot chamber through an oblong opening than a round opening.

The lower inlet funnel may have a length that is at least half of the circumference of the antechamber.

The effect of the lower inlet funnel covering at least half the circumference of the antechamber is that the fish can swim in through the lower inlet funnel from several sides.

The lower inlet funnel may surround the antechamber.

When the lower inlet funnel surrounds the antechamber, the fish may swim into the antechamber from all sides of the pot.

The top ring may constitute a buoyancy body.

The effect of the top ring possibly constituting a buoyancy body is that the side wall may be extended to a maximum height so that the pot chamber may form a maximum volume when the pot is being lowered down the water column, without the use of a rigid connection between the top ring and the intermediate ring.

The buoyancy may be created by air in the top ring. The buoyancy may be created by a buoyant material arranged in or externally on the top ring.

When the pot is stored in the open air, for example on a vessel or on land, the surrounding side wall of the pot chamber may be folded together so that the top ring, the side wall and the pot top may rest against the bottom ring and in the antechamber.

### BRIEF DESCRIPTION OF THE DRAWINGS

In what follows, an example of a preferred embodiment is described, which is visualized in the accompanying drawings, in which:

FIG. 1 shows a pot according to the invention in perspective;

FIG. 2 shows the pot seen from above;

FIG. 3 shows a section of the pot;

FIG. 4 shows an alternative embodiment of the lower inlet funnel;

FIG. 5 shows a pot folded together; and

FIG. 6 shows a plurality of pots stacked.

### DETAILED DESCRIPTION OF THE DRAWINGS

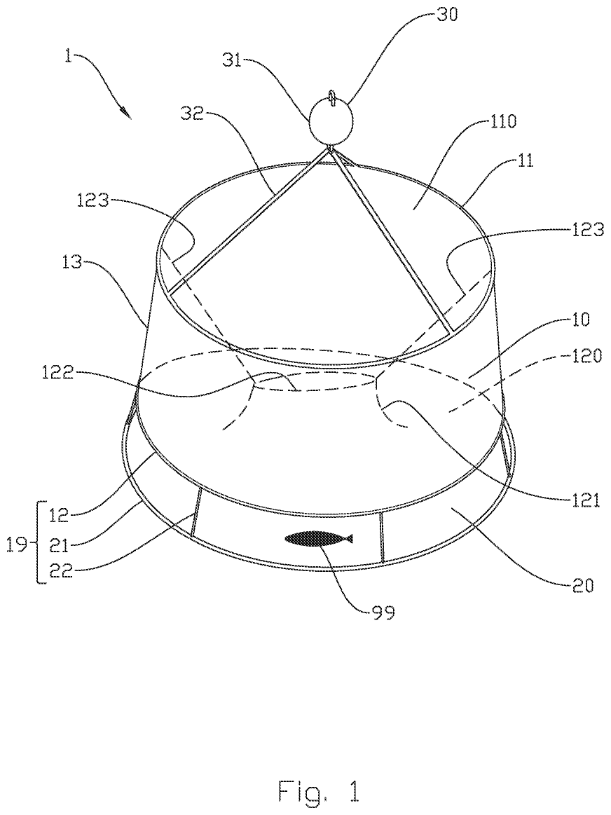

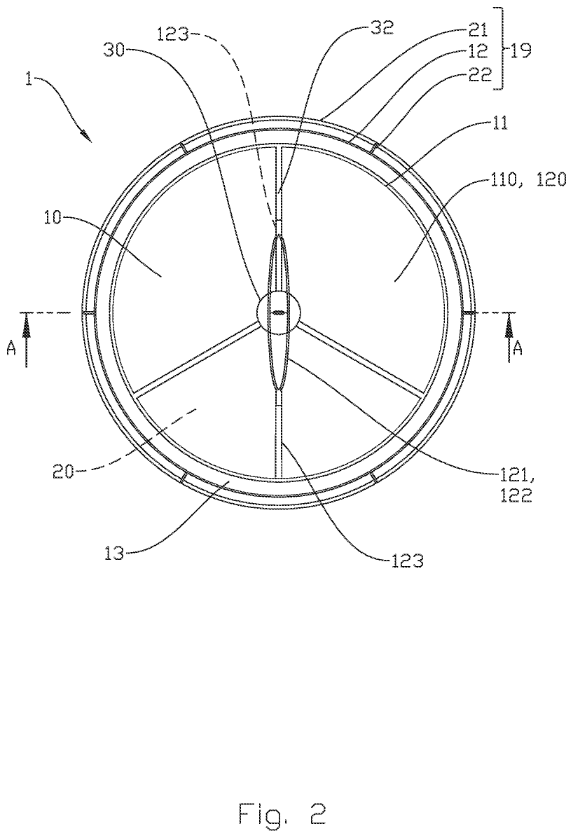

FIGS. 1 and 2 show a pot 1 according to the invention in perspective and from above, respectively. The pot 1 comprises a pot chamber 10, a framework 19, an antechamber 20 and a suspension 30.

A top ring 11 surrounds a pot top 110. A bottom ring 12 surrounds a pot bottom 120. A surrounding side wall 13 is formed between the top ring 11 and the bottom ring 12. The top ring 11 constitutes a buoyancy body. When the pot 1 is lowered in a water column, the buoyancy of the top ring 11 will ensure that the side wall 13 is extended to a full height as shown in FIGS. 1, 3 and 4.

The framework 19 includes the bottom ring 12 and a lower frame ring 21. The bottom ring 12 and the lower frame ring 21 are interconnected via a plurality of braces 22, and with a spacing that makes it possible for a fish 99 to swim into the antechamber 20 between the lower frame ring 21 and the bottom ring 12.

The pot top 110, pot bottom 120 and the side wall 13 are formed of a net (not shown). The net has a mesh that can be adapted for the fish 99 that is to be caught.

The pot bottom 120 includes a primary inlet funnel 121 that extends inwards and upwards in the pot chamber 10. The primary inlet funnel 121 is shown with an oblong opening 122. Two connecting elements 123 are attached, at first end portions, to the top ring 11 and, at second end portions, to the oblong opening 122. The two connecting elements 123 pull the primary inlet funnel 121 inwards in the pot chamber 10, ensuring that the opening 122 of the primary inlet funnel 121 forms the oblong shape.

The suspension 30 comprises a buoyancy body 31 and a plurality of connecting elements 32 arranged to give an even load on the top ring 11 when the pot 1 is lifted by the suspension 30.

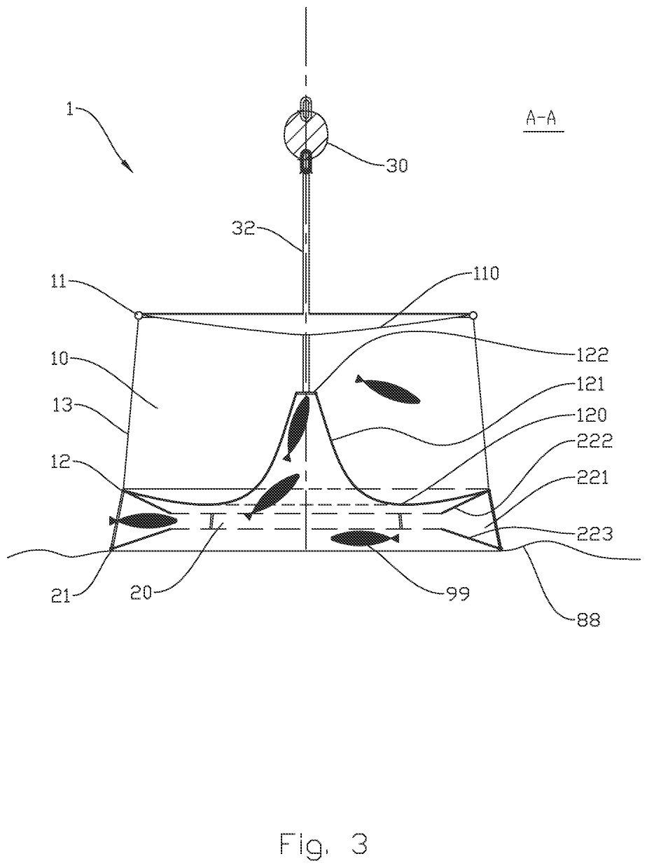

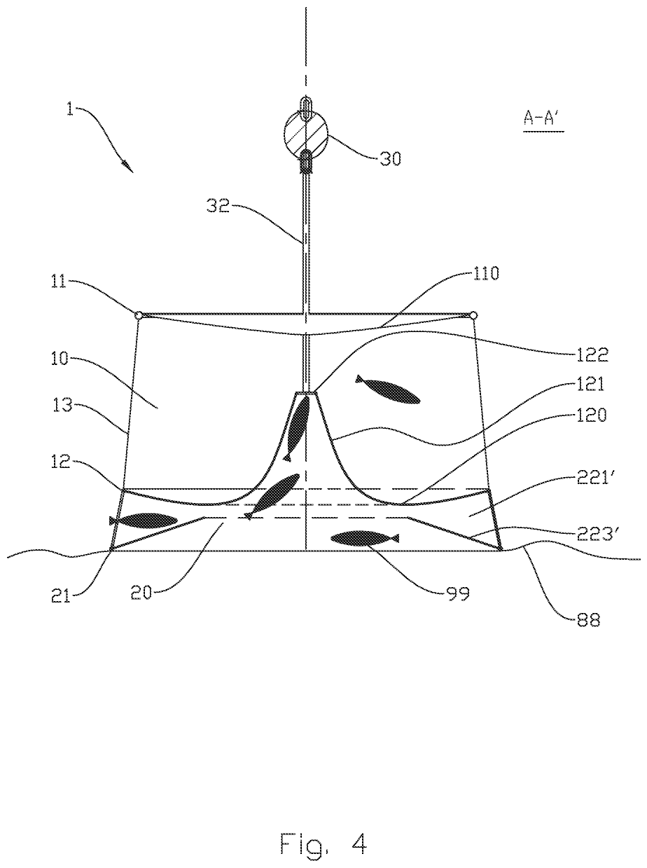

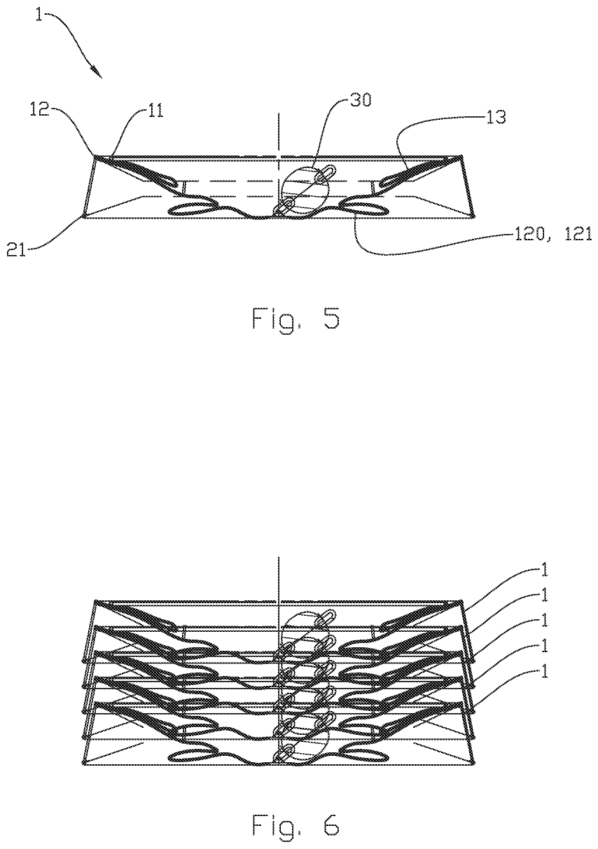

FIG. 3 shows the pot 1 with a lower inlet funnel 221 arranged between the pot bottom 120 and the lower frame ring 21. The lower inlet funnel 221 is formed as an inward-facing, slot-shaped inlet. The lower inlet funnel 221 is shown with an upper collar 222 and a lower collar 223. When the fish 99 has swum through the lower inlet funnel 221 and is inside the antechamber 20, the easiest way further for the fish 99 will be upwards in the water column, through the primary inlet funnel 121 and into the pot chamber 10.

In the figure, the primary inlet funnel 121 is shown as part of the pot bottom 120, the inlet funnel 121 and the pot bottom 12 being formed of a common net.

FIG. 4 shows an alternative embodiment of the lower inlet funnel 221′. The upper collar 221 shown in FIG. 3 has been removed and the slot-shaped inlet is formed of the pot bottom 120 and a long lower collar 223′ extending further into the antechamber 20 than the lower collar 223 shown in FIG. 3.

FIG. 5 shows the pot 1 in a folded position. The top ring 11 has a diameter which is smaller than the diameter than the bottom ring 12. When the pot 1 is not in the water, the pot top 110 and the side wall 13 may be folded into the antechamber 20, and the top ring 11 may be laid inside of the bottom ring 12. Thereby the pot 1 may form a storing height that is substantially equal to the height of the framework 19.

FIG. 6 shows a plurality of pots 1, more precisely five pots 1, stacked on top of each other. As the antechamber 20 has a conical shape, the pots 1 can be stacked in a space-effective manner as shown in FIG. 5.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. A pot arranged for catching a fish, the pot comprising:
a top ring surrounding a pot top;
a bottom ring surrounding a pot bottom;
a surrounding side wall which is formed between the top ring and the bottom ring, wherein the pot top, the pot bottom and the side wall form a pot chamber, and the pot bottom includes a primary inlet funnel extending inwards in the pot chamber,
wherein
under the pot bottom, a framework is arranged, comprising the bottom ring and a lower frame ring arranged to rest against a sup-porting surface;
the framework forms an antechamber arranged to house a fish; and
along an outer circumference of the antechamber, between the bot-tom ring and the lower frame ring, a lower inlet funnel extending inwards in the antechamber is arranged.

2. The pot according to claim 1, wherein the lower frame ring has a diameter which is larger than the bottom ring so that the framework forms a conical shape.

3. The pot according to claim 1, wherein the bottom ring and the lower frame ring are circular.

4. The pot according to claim 1, wherein the lower inlet funnel has a length which is at least half of the circumference of the antechamber.

5. The pot according to claim 1, wherein the lower inlet funnel surrounds the antechamber.

6. The pot according to claim 1, wherein the top ring constitutes a buoyancy body.

7. The pot according to claim 2, wherein the bottom ring and the lower frame ring are circular.

8. The pot according to claim 2, wherein the lower inlet funnel has a length which is at least half of the circumference of the antechamber.

9. The pot according to claim 3, wherein the lower inlet funnel has a length which is at least half of the circumference of the antechamber.

10. The pot according to claim 2, wherein the lower inlet funnel surrounds the antechamber.

11. The pot according to claim 3, wherein the lower inlet funnel surrounds the antechamber.

12. The pot according to claim 2, wherein the top ring constitutes a buoyancy body.

13. The pot according to claim 3, wherein the top ring constitutes a buoyancy body.

14. The pot according to claim 4, wherein the top ring constitutes a buoyancy body.

15. The pot according to claim 5, wherein the top ring constitutes a buoyancy body.
